(19) United States
(12) Patent Application Publication
(10) Pub. No.: US 2008/0157563 A1
(43) Pub. Date: Jul. 3, 2008

(54) Front end module integrated, adjustable fascia or top cap support system

(75) Inventors: Michael Crane, Oakland Township, MI (US); Thomas M. Pilette, Lake Orion, MI (US); Martin R. Matthews, Troy, MI (US); Anthony J. Povinelli, Romeo, MI (US)

Correspondence Address: WARN, HOFFMANN, MILLER & LALONE, .P.C, PO BOX 70098, ROCHESTER HILLS, MI, 48307, US

(73) Assignee: Magna International Inc., Aurora (CA)

(21) Appl. No.: 11/645,853

(22) Filed: Dec. 27, 2006

(51) Int. Cl. B60R 27/00

(52) U.S. Cl. 296/187.01

(57) ABSTRACT

A The present invention is a support system for a panel having a carrier member to which a component support structure is attached, at least one component support structure to which a first externally visible component and the contoured finish panel require attachment, a first attachment structure for providing fixed position attachment of the first externally visible component, and a support member having a contoured surface for supported the contoured finished panel in a fixed position. The present invention also includes a second attachment structure which provides adjustable positioning of the support member to the support structure such that a close tolerance fit can be facilitated between the first externally visible component and the contoured finish panel by selecting the position of the support member.

### FIELD OF THE INVENTION

The present invention relates to support assemblies which are used in the front end of an automobile; more particularly, the present invention relates to a support member which is used for supporting a front fascia or top cap in an automobile, as well as controlling the relative positioning between a headlamp assembly and the front fascia or top cap in an automobile.

### BACKGROUND OF THE INVENTION

Fascias or top caps are generally known and used throughout various types of automobiles. The fascia or top cap is a portion of the body which is typically positioned near, or below the headlights and grille, and is used for providing an aesthetically pleasing appearance. However, typical fascias, as well as top caps, are lacking in support in an area below the headlights and in front of the grill of the automobile. These fascias and top caps are typically made of a composite material which can be difficult to dimension, as well as position relative to the headlights such that the correct dimensions are achieved.

Often during assembly, due to tolerances and other manufacturing causes, the position of the headlight relative to the fascia or top cap is too large, leaving a gap between the headlight and the fascia or top cap, which detracts from the appearance of the automobile. It is desired to have a minimal gap between the headlight and front fascia or top cap of the automobile.

Accordingly, there exists a need for an improved way of controlling the dimensions between the headlight and the front fascia or top cap, as well as providing support for the front fascia or top cap.

### SUMMARY OF THE INVENTION

The present invention is a support system for a panel having a carrier member to which a component support structure is attached, at least one component support structure to which a first externally visible component and the contoured finish panel require attachment, a first attachment structure for providing fixed position attachment of the first externally visible component, and a support member having a contoured surface for support of the contoured finished panel in a fixed position.

The present invention also includes a second attachment structure which provides adjustable positioning of the support member to the support structure such that a close tolerance fit can be facilitated between the first externally visible component and the contoured finish panel by selecting the position of the support member.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view of a front end assembly support system for a top cap, according to the present invention;

FIG. 2 is a perspective view of a front end assembly support system for a top cap with the headlamp removed, according to the present invention;

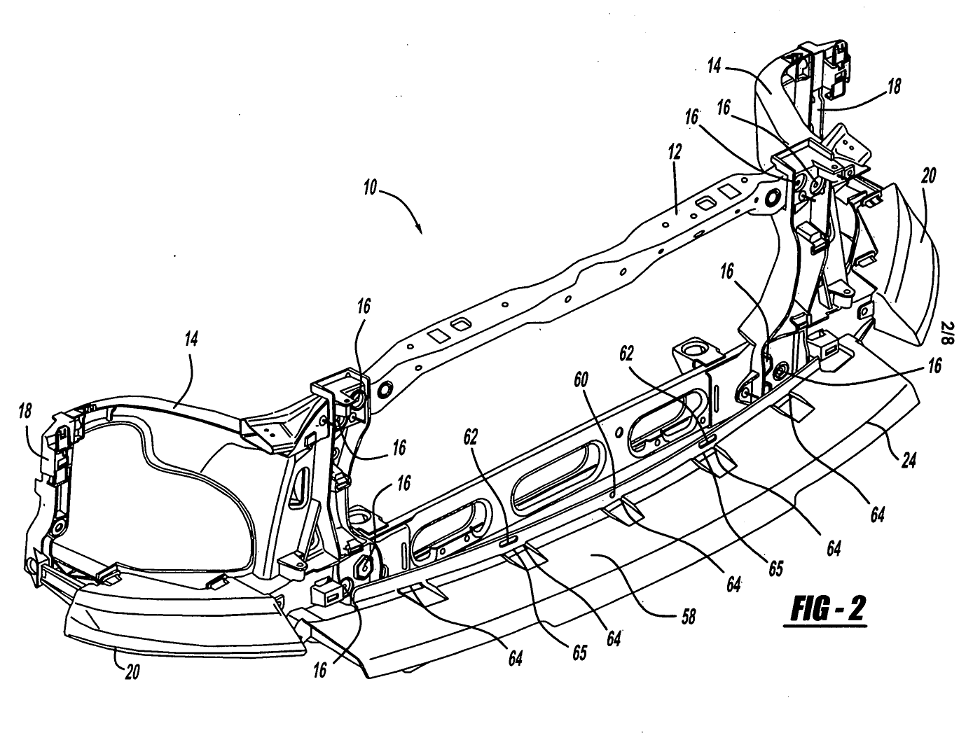

FIG. 3 is an enlarged perspective view of a support system used for a top cap, according to the present invention;

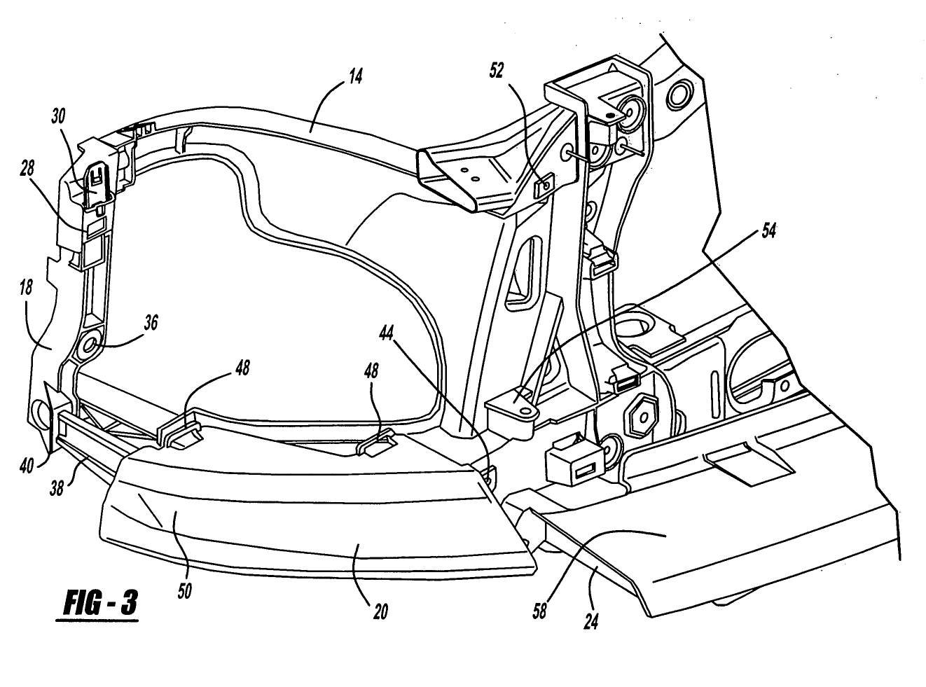

FIG. 4 is an enlarged front view of a support system for a top cap, according to the present invention;

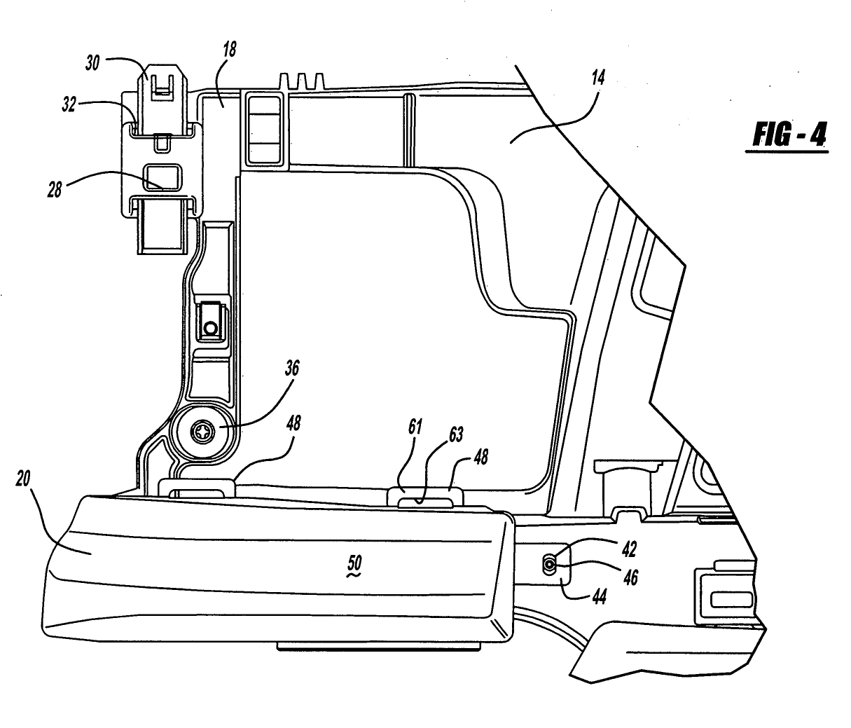

FIG. 5 is an enlarged perspective rear view of a support system for a front fascia or top cap, according to the present invention;

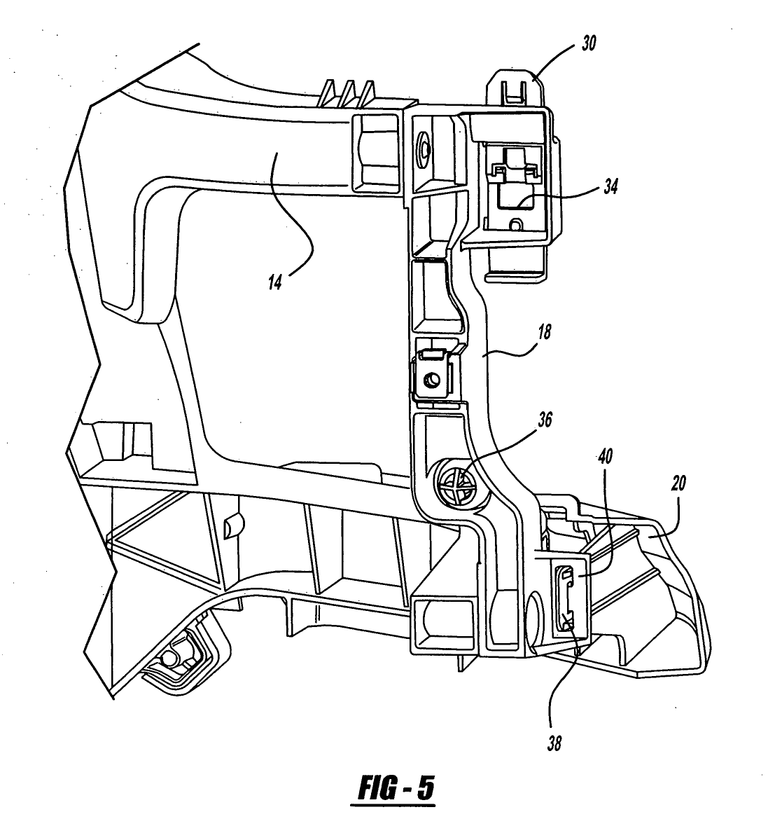

FIG. 6 is a perspective view of a support system for a top cap with the top cap attached, according to the present invention;

FIG. 7 is an enlarged perspective rear view of a support system with the top cap attached, according to the present invention; and

FIG. 8 is a perspective rear view of a bracket headlamp carrier used in a support system, according to the present invention.

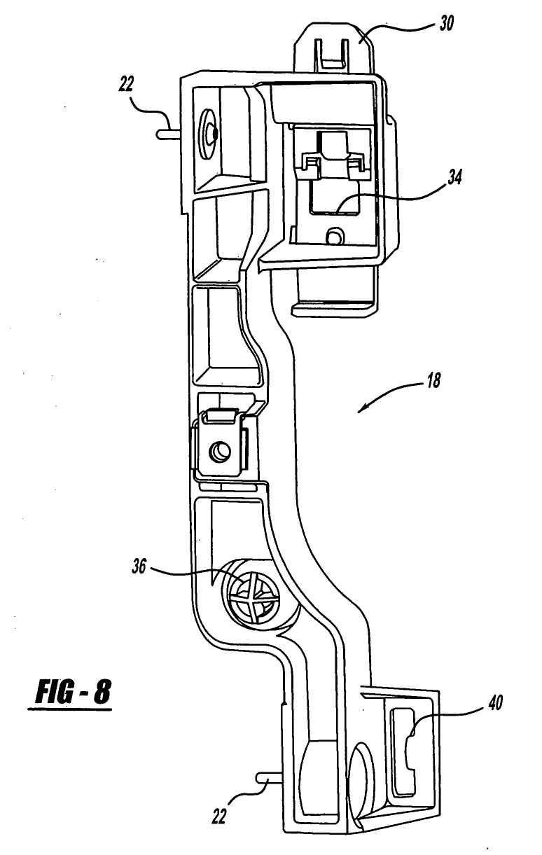

### DETAILED DESCRIPTION OF THE PREFERRED EMBODIMENTS

The following description of the preferred embodiment(s) is merely exemplary in nature and is in no way intended to limit the invention, its application, or uses.

Referring to the Figures, a support system for a contoured finish panel, more specifically a top cap or a fascia is shown generally at 10. The system 10 includes a carrier member, which in this embodiment is a carrier 12 which is used for supporting various vehicle components, such as a radiator, hood, fan, fan shroud, windshield washer fluid container, various hoses, and the like. Attached on each side of the carrier 12 are lamp supports 14. The lamp supports 14 are attached through the use of an adhesive bond and rivets 16. The adhesive bond is placed between the carrier 12 and the lamp supports 14, the rivets 16 are then attached and hold the carrier 12 and lamp supports 16 together until the adhesive bond cures.

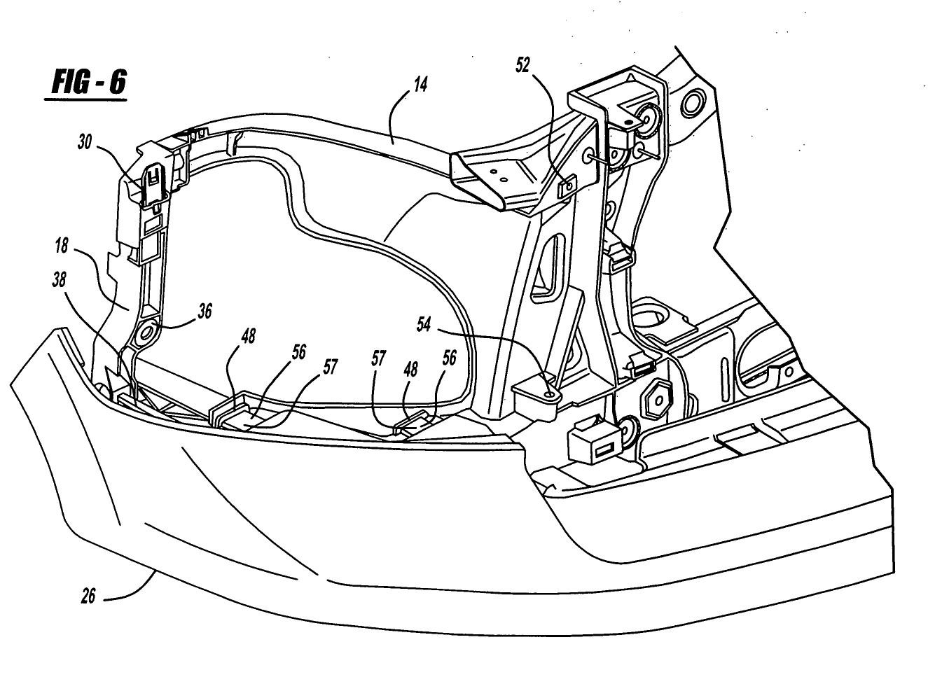

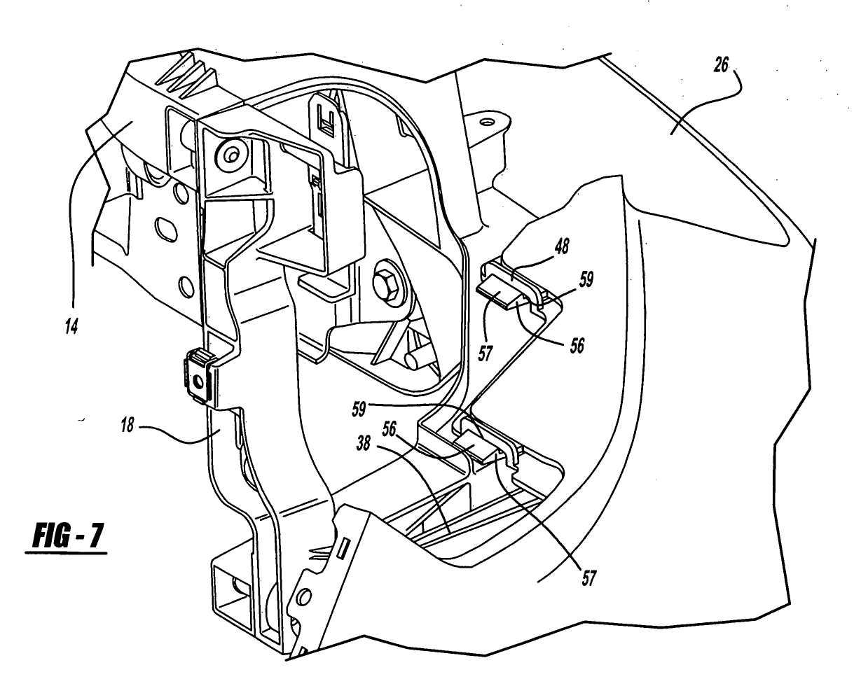

Attached to each of the lamp supports 14 is a bracket headlamp carrier 18, and a support member 20. The bracket headlamp carrier 18 is attached to the carrier 12 through the use of fasteners, shown as bolts 22 in FIGS. 6 and 7, and the lamp supports 14 along with the bracket headlamp carrier 18 forms a component support structure. Also attached to each of the headlamp supports 14 is a center support 24. The support member 20 and the center support 24 are used for supporting a contoured finish panel of the body of a vehicle, which in this embodiment is a top cap 26. The top cap 26 is used to provide an aesthetically pleasing appearance and is typically the same color as the remaining body components.

During assembly, a first externally visible component, which in this embodiment is a lamp assembly in the form of a headlamp 27, is attached to the bracket headlamp carrier 18 using an aperture 28 and tab 30. The tab 30 is received in a slot 32 in the bracket headlamp carrier 18. The tab 30 has a corresponding aperture 34 such that when the aperture 28 and corresponding aperture 34 are aligned, the aperture 28 and corresponding aperture 34 will receive a protrusion from the headlamp 27. Once inserted, the tab 30 is moved in the slot 32 so as to offset the aperture 28 and the aperture 34 of the tab 30, and engage the protrusion of the headlamp 27, securing the headlamp 27 to the bracket headlamp carrier 18. The headlamp 27 also includes a ball which is received in a socket 36. The socket 36 allows for the position of the headlamp 27 to be changed, and compensates for various tolerances.

The support member 20 is connected to the bracket headlamp carrier 18 through the use of an extension 38 which is connected to a bracket 40; the support member 20 is also connected to the lamp support 14 through the use of fastener, such as a screw (not shown) inserted through a slot 42 in a flange 44 and through a corresponding aperture 46 in the lamp support 14. The support member 20 also includes snaps 48, the function of which will be described later, and a contoured surface 50 for supporting the top cap 26.

The headlamp 27 is also attached to the lamp supports 14 through the use of an upper connector 52 and a lower connector 54. The upper connector 52, lower connector 54, the slot 32 and tab 30, and the ball and socket 36 form a first attachment structure for connecting the headlamp 27 to the lamp support 14 and bracket headlamp carrier 18. The flange 44 and the slot 42, and the corresponding aperture 46 form a first attachment point; the extension 38 and bracket 40 form a second attachment point. Both the first attachment point and second attachment point form a second attachment structure for attaching the support member 20 to the lamp support 14 and the bracket headlamp carrier 18.

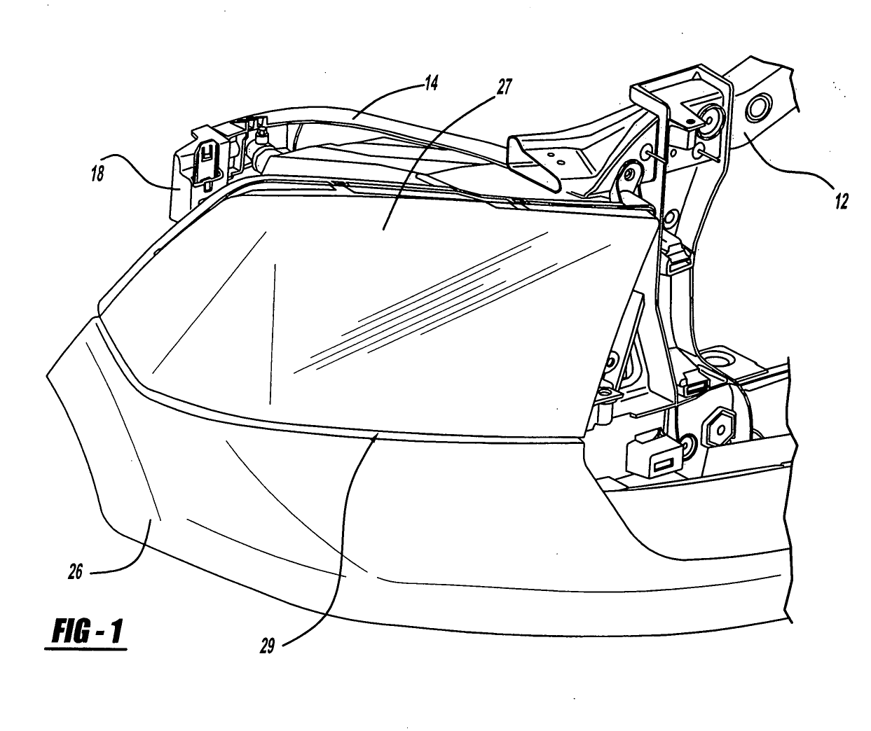

Once the headlamp 27 is attached to the lamp support 14, and the bracket headlamp carrier 18, the position of the support member 20 can be adjusted using the extension 38 and bracket 40, along with the fastener inserted through the slot 42 and aperture 46. The slot 42 is shaped so as to allow the position of the support member 20 to be adjusted during assembly relative to the lamp support 14. Adjusting the position of the support member 20 relative to the lamp support 14 secures the position of the support member 20, and therefore secures the position of the top cap 26 relative to the headlamp 27, allowing for control over the amount of space between the headlamp 27 and top cap 26. The space between the headlamp 27 and top cap 26 is shown as a gap generally at 29 in FIG. 1.

Referring to FIGS. 6 and 7, the top cap 26 includes a set of extensions 56 having an angled tab 57 and a contact surface 59 which are received into the snaps 48 of the support member 20. The snaps 48 have a frame member 61 and an aperture 63. The angled tab 57 is inserted through the aperture 63 until the contact surface 59 contacts the frame member 61. The contoured surface 50 of the support member 20 provides support for the top cap 26.

The center support 24 also includes a contoured surface 58, which also provides support for the top cap 26. The center support 24 includes a centering aperture 60, a series of grille snaps 62 having an aperture 66, and top snaps 64 having an aperture 68. A second externally visible member, which in this embodiment is an exterior body component in the form of a grille (not shown), is attached to the center support 24 through the use of the grille snaps 62. The grille has extensions (not shown) which include angled tabs and contact surfaces, and are inserted into the grille snaps 62 in the same manner as the extensions 56 of the top cap 26 are inserted into the snaps 48. The grille is properly aligned with the center support 24 by using the centering aperture 60. After the grille is attached, the top cap 26 is attached using a set of extensions (not shown) having an angled tab and contact surface, which are similar to the extensions 56 inserted into the snaps 48, and are inserted into the top snaps 64 in a similar manner that the extensions 56 are inserted into the snaps 48.

The center support 24 is formed such that once the grille and the top cap 26 are both attached to the center support 24, the desired distance between the grille and top cap 26 is achieved to provide an aesthetically pleasing appearance. The top snaps 62, and extensions of the top cap 26 form a first attachment assembly for connecting the top cap 26 to the center support 24, and the grille snaps 62 along with the extensions of the grille form a second attachment assembly for connecting the grille to the center support 24.

It should be noted that the top cap 26 could also be replaced with a fascia. The fascia would also have extensions which would be received by the snaps 48 of the support member 20 and the top snaps 64 of the center support 24, and supported by the contoured surface 50 of the support member 20 and the contoured surface 58 of the center support 24 in the same manner as the top cap 26.

While it has been shown that the support member 20 has been used with the carrier 12 and lamp supports 14, the support member 20 is made through a forming process, such as injection molding, and can be made to fit any type of vehicle having any type of top cap 26 or front fascia.

The description of the invention is merely exemplary in nature and, thus, variations that do not depart from the essence of the invention are intended to be within the scope of the invention. Such variations are not to be regarded as a departure from the spirit and scope of the invention.

What is claimed is:

1. A support system for a contoured finish panel, comprising:
a carrier member to which a component support structure is attached;
at least one component support structure to which a first externally visible component and said contoured finish panel require attachment;
a first attachment structure for providing fixed position attachment of said first externally visible component;
a support member having a contoured surface for supported said contoured finished panel in a fixed position; and
a second attachment structure which provides adjustable positioning of said support member to said support structure such that a close tolerance fit can be facilitated between said first externally visible component and said contoured finish panel by selecting the position of said support member.

2. The support system for a contoured finish panel of claim 1, said second attachment structure further comprising a securement structure for securing said support member in the selected position.

3. The support system for a contoured finish panel of claim 2, wherein said second attachment structure allows for vertical adjustment of said support member relative to said at least one component support structure.

4. The support system for a contoured finish panel of claim 1, said second attachment structure further comprising a first attachment point and a second attachment point for selectable adjusting of the position of said support member relative to said first externally visible component.

5. The support system for a contoured finish panel of claim 4, said first attachment point further comprising:
a flange having a slot, said flange connected to said support member; and
a corresponding aperture disposed in said component support structure and aligned with said slot such that a said flange is repositioned relative to said corresponding aperture to adjust the position of said support member relative to said component support structure, and a fastener inserted through said slot into said corresponding aperture to secure the position of said support member relative to said component support structure.

6. The support system for a contoured finish panel of claim 4, said second attachment point further comprising:
said support member having an extension; and
said component support structure having a bracket for receiving said extension, allowing the position of said support member to be adjusted relative to said component support structure.

7. The support system for a contoured finish panel of claim 1, said support member further comprising a series of snaps for connecting said contoured finish panel to said support member.

8. The support system for a contoured finish panel of claim 7, each of said series of snaps further comprising frame member having an aperture, and said contoured finish panel further comprises a series of extensions having an angled tab which includes a contact surface, and said series of extensions are inserted through said aperture such that said contact surface contacts said frame member.

9. The support system for a contoured finish panel of claim 1, wherein said first externally visible component is a headlamp assembly.

10. The support system for a contoured finish panel of claim 1, wherein said contoured finish panel is one selected from the group comprising a top cap, a fascia, or a quarter panel.

11. The support system for a contoured finish panel of claim 1, wherein said support structure is integral with said carrier member.

12. The support system for a contoured finish panel of claim 1, wherein said support structure is a separate component from said carrier member.

13. The support system for a contoured finish panel of claim 1, wherein said manufacturing tolerance between said support member and said first externally visible component is four millimeters or less.

14. The support system for a panel of claim 1, further comprising a center support for supporting said contoured finish panel

15. The support system for a contoured finish panel of claim 14, said center support further comprising:
at least one top snap for connecting said center support to said contoured finish panel;
at least one grille snap for connecting said center support to a second externally visible member;
at least one centering aperture for aligning said second externally visible member with said center support; and
when said second externally visible member and said contoured finish panel are connected to said center support, said second externally visible member will remain stationary relative to said panel when the position of said center support is adjusted relative to said carrier member.

16. The support system for a contoured finish panel of claim 15, said second externally visible member is a grille for an automobile.

17. A support system for a contoured finish panel disposed on the outside of a vehicle, comprising:
a carrier having at least one lamp support, said at least one lamp support having a bracket headlamp carrier;
a lamp assembly connected to said at least one lamp support and said bracket headlamp carrier;
at least one support member connected to said at least one lamp support and said bracket headlamp carrier;
a first attachment structure for connecting said lamp assembly to said at least one lamp support and said bracket headlamp carrier;
a second attachment structure for connecting said at least one support member to said at least one lamp support and said bracket headlamp carrier; and
a contoured finish panel connected to and supported by said support member such that as the position of said carrier varies relative to said lamp assembly and said panel during the assembly of said carrier, said at least one lamp support, said bracket headlamp carrier, said support member, and said contoured finish panel, said contoured finish panel is in a fixed location relative to said lamp assembly.

18. The support system for a contoured finish panel disposed on the outside of a vehicle of claim 17, said at least one support member further comprising:
a series of snaps having a frame member and an aperture for receiving a series of extensions on said panel, said extensions of said panel having an angled tab and a contact surface; and
said angled tab of each of said series of extensions is inserted through said aperture of said frame member until said contact surface contacts said frame member to maintain the position of said contoured finish panel relative to said lamp assembly.

19. The support system for a contoured finish panel disposed on the outside of a vehicle of claim 17, said first attachment structure further comprising:
a lower connector and an upper connector formed in said at least one lamp support;
a ball extending from said lamp assembly, received by a socket, said socket connected to said bracket headlamp carrier;
a tab having an aperture slidably disposed within a slot having an aperture, said lamp assembly having a protrusion inserted through said aperture of said slot and said aperture of said tab such that said tab is moved in said slot to engage said protrusion of said lamp assembly; and
when said tab is engaged with said lamp assembly, said ball is received by said socket, and said lamp assembly is connected to said upper connector and said lower connector, said lamp assembly is connected to said at least one lamp support.

20. The support system for a contoured finish panel disposed on the outside of a vehicle of claim 17, said second attachment structure further comprising:
a first attachment point having a flange having a slot connected to said support member, and a corresponding aperture formed in said at least one lamp support
a second attachment point having an extension formed as a portion of said support member received in a bracket in said bracket headlamp carrier; and
the position of said flange relative to said corresponding aperture formed in said at least one lamp support is adjusted to move said support member relative to said lamp assembly such that a close tolerance fit is facilitated between said lamp assembly and said contoured finish panel.

21. The support system for a contoured finish panel disposed on the outside of a vehicle of claim 17, wherein said contoured finish panel is one selected from the group comprising top cap, a fascia, and a quarter panel.

22. A support system for a contoured finish panel, comprising:
a center support connected to a carrier member;
a contoured finish surface connected to said center support using a first attachment assembly;
a exterior body component connected to said center support using a second attachment assembly; and
as said center support is moved relative to said carrier member, said contoured finish surface remains in a substantially fixed position relative to and said exterior body component.

23. The support system for a contoured finish panel of claim 22, said exterior body component further comprises a grille.

24. The support system for a contoured finish panel of claim 22, said first attachment assembly comprising:
a plurality of top snaps having an aperture formed as a portion of said center support;
a plurality of extensions formed as a portion of said contoured finish panel, each of said plurality of extensions having an angled tab and a contact surface; and
said angled tab of each of said plurality of extensions is inserted into said aperture of said plurality of top snaps such that said contact surface of said plurality of extensions is in contact with said plurality of top snaps.

25. The support system for a contoured finish panel of claim 22, said second attachment assembly further comprising:
a plurality of grille snaps having an aperture formed as a portion of said center support;
a plurality of extensions formed as a portion of said exterior body component, each of said plurality of extensions having an angled tab and a contact surface; and
said angled tabs of each of said plurality of extensions of said exterior body component are inserted into said apertures of said plurality of grille snaps, causing said contact surface to contact said plurality of grille snaps, attaching said exterior body component to said center support.
